(19) United States
(12) Patent Application Publication
(10) Pub. No.: US 2007/0154669 A1
(43) Pub. Date: Jul. 5, 2007

(54) Veil material for implements

(75) Inventors: Marcus Schneider, South Bend, IN (US); Jao Chang, South Bend, IN (US)

Correspondence Address: BARNES & THORNBURG LLP, P.O. BOX 2786, CHICAGO, IL, 60690-2786, US

(73) Assignee: Polygon Company

(21) Appl. No.: 11/324,922

(22) Filed: Jan. 4, 2006

(51) Int. Cl. B29C 70/08

(52) U.S. Cl. 428/36.3; 428/151; 264/136; 264/171.26

(57) ABSTRACT

A substantially rigid, fiber reinforced polymer composite article that includes a preprinted veil layer covered with a substantially transparent capstock that is designed to be used for implement handles, such as shovels and rakes or can be used for decking and fencing material. The fiber reinforced polymer composite article is formed of by using pre-impregnated fiberglass rovings or fibers encapsulated in a thermoplastic capstock that are pultruded through one or more dies and coated with a veil material. The veil material includes a pattern that, when applied to the fibrous layer can create the appearance of wood or simulate other materials. The veil layer is then coated with a transparent or substantially transparent capstock by means of extrusion to produce the fiber reinforced polymer composite article.

### BACKGROUND

This disclosure relates to a fiber reinforced material and more specifically to a substantially rigid, fiber reinforced polymer composite article for implements and the process of manufacture.

By way of background but not limitation, typical composite articles used for implements, such as shovels or for decking material are manufactured by passing a plurality of filaments or fibers through a resin bath and then into a long heated die tube to produce a cured composite profile defined by the shape of the die. The filaments are bonded by the resin and, are cured by heat to form a fibrous resin composite. The composite material is typically coated with a final resin top coat having a colorant or the exterior surface is coated with paint. Articles manufactured from this process often result in fibers that extend past the surface of the article, which can irritate the users hands and also results in wear of the surface colorant. Further the overall appearance of the article is governed by the color top coat.

In view of the above, it should be appreciated that there is a need for a substantially rigid, fiber reinforced polymer composite article that includes a preprinted veil layer covered with a substantially transparent capstock to prevent the glass fibers from piercing the surface of the article and to create the appearance of wood or other patterns. The present invention satisfies these and other needs and provides further related advantages.

### SUMMARY

The invention comprises a substantially rigid, fiber reinforced polymer composite article that includes a preprinted veil layer covered with a substantially transparent capstock that is designed to be used for implement handles, such as shovels and rakes or can be used for decking, wood posts, trellises, and fencing material. The fiber reinforced polymer composite article is formed by using pre-impregnated fiberglass rovings or fibers encapsulated in a thermoplastic capstock that are pultruded through one or more dies and coated with a veil material. The veil material includes a pattern that, when applied to the fibrous layer can create the appearance of wood or simulate other materials. The veil layer is then coated with a transparent or substantially transparent capstock by means of extrusion to produce the fiber reinforced polymer composite article.

Other features and advantages of the invention will be set forth in part in the description which follows and the accompanying drawings, where the embodiments of the disclosure are described and shown, and in part will become apparent upon examination of the following detailed description taken in conjunction with the accompanying drawings.

### BRIEF DESCRIPTION OF THE DRAWINGS

The above-mentioned and other features of this disclosure in the manner of obtaining them will become more apparent and the disclosure itself will be best understood by reference to the following description of elements of the disclosure taken in conjunction with the accompanying drawings in which:

FIG. 1 is a perspective view of the fiber reinforced polymer composite article of the present invention.

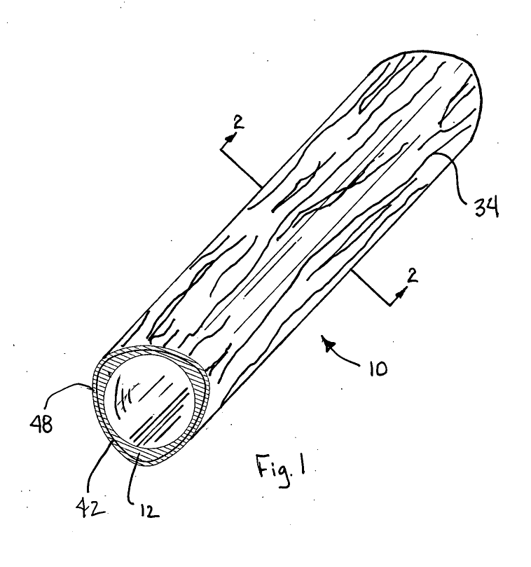

FIG. 2 is a cross-sectional view of the composite article; taken along lines 2-2.

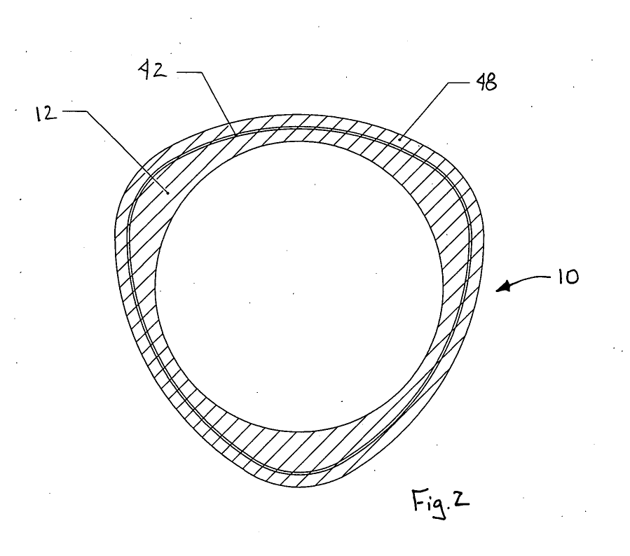

FIG. 3 is a schematic, side elevation of an apparatus suitable for practice of the method of the present invention; and

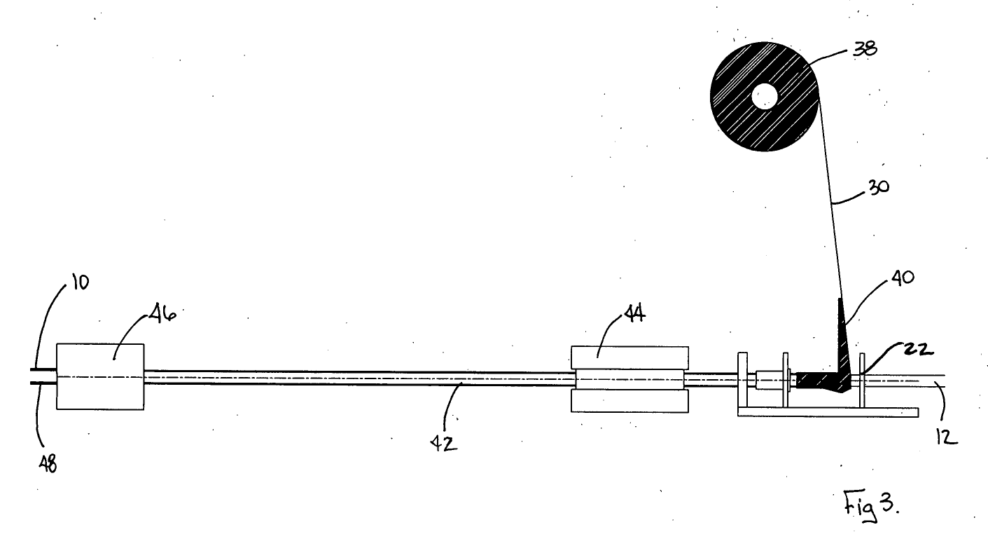

FIG. 4 is a perspective view of the composite article used with an implement.

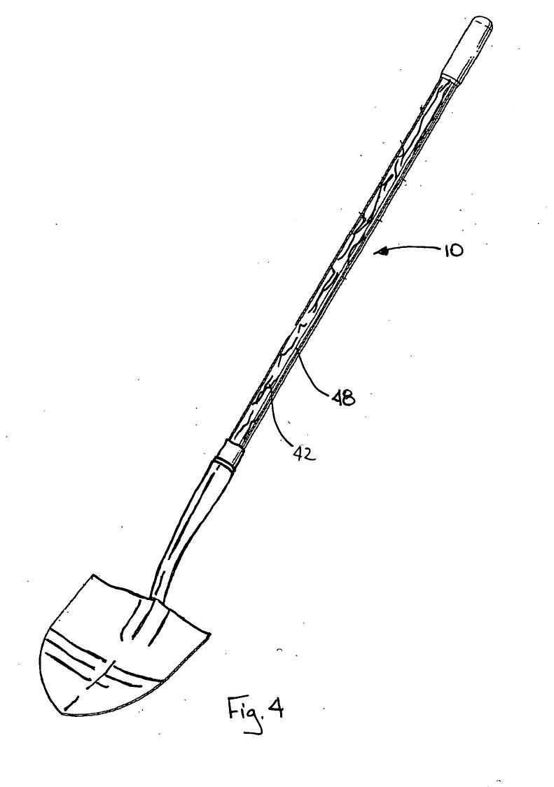

### DETAILED DESCRIPTION

While the present invention will be described fully herein with reference to the accompanying drawings, in which a particular embodiment is shown, it is to be understood that the person skilled in the art may modify the disclosure herein described while still achieving the desired result of this disclosure. Accordingly, the description that follows is to be understood as a broad and informative disclosure directed to persons skilled in the appropriate art and not as limitations on the present disclosure.

As illustrated in the drawings, a fiber reinforced polymer composite article 10 is adapted to be used as handle material for implements such as shovels, rakes, pruning sheers and the like and also is designed to be used for decking, railings and fencing.

While the article 10 is a polymer composite, it is designed to have the outward appearance of real wood when observed by the user. While a wood grain pattern is preferred, it is contemplated that other visual patterns can be created while still practicing the teachings of the disclosure including camouflage, steel, sports logos, among others and is not limited to a particular type of pattern. The fiber reinforced polymer composite article 10 is comprised of a substantially rigid core layer 12 formed of a plurality of fibers that are inter-connected by a binder material to form the core layer 12. While fiberglass fibers are preferred, it should be recognized that other types of reinforcements such as carbon, aramid or a variety of man made or natural fibers can be used for the fibers.

Although the preferred fiberglass fibers are individually fragile. They typically have a high tensile strength. Great strength values are realized when the individual fibers are bonded together by the thermoplastic binder material to disburse an applied load amongst the fibers. Use of the thermoplastic binder material permits the thermoplastic veil layer 42 to bind to the core layer 12 without the use of adhesives.

The binder material is in the form of a thermoplastic polymer including but not limited to polypropylene. The fibers are pre-coated with the polymer binder material before the manufacture of the composite article 10. In manufacturing the core layer 12 a plurality of pre-coated fiber glass fibers are unraveled from spools and are passed through one or more heated rollers. The heated rollers melt the thermoplastic binder material surrounding the fibers to permit adjacent fibers to adhere to one another.

The fibers from the heated rollers are then passed through several forming dies 22 to form a desired profile. The forming dies includes an inner mandrel and an outer die body to form the profile of the core layer 12. While a mandrel is used in the preferred embodiment, to create the hollow core, it is contemplated that the polymer material can be pultruded without the mandrel to form solid core layer 12 without a hollow core. Since the fiberglass fibers are pultruded through the forming dies 22 the fibers are set in a co-linear arrangement. The co-linear arrangement of the fibers increases the longitudinal strength of the composite article 10. After the fiberglass fibers exit the forming dies 22, the desired core layer 12 shape is formed.

While the binder material is still in a melted state, a veil tape 30 is applied to the exterior surface 32 of the core layer 12. The veil tape 30 is applied so that it substantially surrounds the exterior surface of the core layer 12. The term “substantially surrounds” is used because it is possible that less than the entire perimeter of the core layer 12 is covered when the veil tape 30 is applied due to manufacturing tolerances or an appearance that is desired by the manufacturer. However, in the preferred embodiment, the entire exterior surface of the core layer 12 is covered with the veil tape 30.

The veil tape 30 is preferably made from polyester but can be manufactured from other materials that serve the same function. The veil tape 30 is preprinted with a wood grain pattern 34 that is applied on the exterior surface of the veil tape 30. The veil tape 30 is stored on a spool 38 and passes through a forming chute 40 that applies the veil tape 30 around the exterior surface of the core layer 12. With the thermoplastic binder material of the core layer 12 still in a melted state the veil tape 30 can bond or fuse to the core layer 12.

Once the veil tape 30 is in position around the core layer 12, it becomes the veil layer 42 of the composite article 10. The core layer 12 and the veil layer 42 then pass through a chill die 44 to solidify the polymer materials. The wood grain veil layer 42 has a preferred thickness of 0.008 inches but can be of varying thicknesses.

Once the core layer 12 and veil layer 42 are cooled, the composite article 10 then passes through an extruder 46 which applies a thermoplastic capstock 48 over the veil layer 42. The thermoplastic capstock 48 is preferably formed from polypropylene but other thermoplastics can be used to accomplish the same result. The thermoplastic capstock surrounds the veil layer 42 and in combination with the veil layer 42 prevents the fiberglass fibers from penetrating the exterior surface of the finished composite article. The capstock 48 is also preferably applied at a thickness of 0.040 inches but is contemplated that other thicknesses may be applied to achieve the same result. The thermoplastic capstock 48 is preferably transparent to permit the printed pattern on the exterior surface of the veil layer 42 to be visible after the capstock 48 is applied. The capstock is also preferably UV resistant to prevent degradation of the printed pattern of the veil layer 42 and to prevent degradation to the polypropylene capstock 48.

The fiber reinforced polymer composite article 10 can be manufacture in a variety of profiles including elliptical, round, triangular, rectangular, or square configurations. Shape is dependent on preference and the intended use of the article. The fiber reinforced polymer composite article 10 is substantially rigid in that visible flexation is not observed in sections less than three feet in length. Of course over extended spans of eight feet or more slight bending or bowing may be observed in the composite article 10.

The process for manufacturing the fiber reinforced polymer composite article 10, while described herein, is summarized as follows. The method for the manufacture of the fiber reinforced polymer reinforced polymer composite article 10 comprises the steps of heating a plurality of thermoplastic preimpregnated fiberglass fibers which pass through and are pultruded through several forming dies 22 to form a profile having a plurality of longitudinal strands of fibers interconnected by the thermoplastic binder material 16. After the thermoplastic and fiber core layer 12 is formed, a polymer veil tape 30 is disposed about the exterior surface of the core layer 12 by use of a forming chute 40. The veil tape 30 is applied by the forming chute 40 to form the veil layer 42 of the composite article 10.

Once the veil tape 30 is applied the fiber and thermoplastic profile 12 and veil 42 are cooled in a chill die 44 to partially solidify the polymer materials. The thermoplastic profile and veil are then passed through the extruder 46 that extrudes a substantially transparent thermoplastic capstock 48 over the polymer veil layer 42 to form the completed fiber reinforced polymer composite article 10.

The completed fiber reinforced polymer composite article 10 provides an outwardly visible wood grain or other pattern that enhances the quality and appearance of the composite article 10. The thermoplastic capstock 48 is preferably applied to create a smooth exterior surface but can be applied to create a textured surface to increase the coefficient of friction between the exterior surface and or a users hands.

From the forgoing it will be appreciated that the present disclosure provides a fiber reinforced polymer composite article 10 that is lightweight, strong and has the outward appearance of natural wood. The composite article 10 is benefited with high strength, high chemical and weather resistance and infinite pattern combinations that can be printed on the veil layer 42. The life of the composite article 10 is essentially infinite and the thermoplastic capstock eliminates the need for varnish that needs to be applied to typical natural wood handles.

The versatility of the composite article 10 permits the article to be profiled in a generally rounded triangular shape for implement handles. Shovel handles of a generally rounded triangular shape have been found to be relatively more comfortable in a users hands for a prolonged period of time than other known cross sectional shapes such as round shapes. The composite article can also be formed in a rectangular shape wherein the width exceeds the depth of the article to permit the use as a decking surface. Again the capstock layer 48 can be formed with a texture to increase the reaction surface of the article.

It should be appreciated that the teachings of the present disclosure are useful for the manufacture of fiber reinforced plastic composite articles 10 that have both structural rigidity as well as decorative and protective surface that can provide functional geometric configurations. Based upon the forgoing disclosure, it should now be apparent that the use of the assemblies described herein will carry out the objects set forth here and above. It should also be apparent to those skilled in the art that the method of the present invention can be practiced to manufacture a variety of fiber reinforced plastic composite articles having the structure described herein. Similarly, the temperatures and pressures of operation and the speed at which the article is continuously formed can readily be determined by those skilled in the art.

It is, therefore, to be understood that any variations evident fall within the scope of the claimed invention and thus, the selection of specific thermoplastics fiber reinforcements veil patterns and method steps can be determined without departing from the spirit of the invention herein disclosed and described. Moreover, the scope of the invention shall include all modifications and variations that may fall within the scope of the attached claims.

What is claimed is:

1. A substantially rigid, fiber reinforced polymer composite article having predetermined dimensions and an outwardly visible pattern when said article is viewed, said article comprising:
a substantially rigid core layer formed from a plurality of fibers, said fibers interconnected by a binder material to form said core layer;
a polymer veil layer substantially disposed about to said core layer, said polymer veil layer having a predetermined pattern that is outwardly visible when said article is viewed; and
a substantially transparent polymer capstock that is binded to a substantial portion of said veil layer, wherein said capstock permits said predetermined pattern of said veil layer to remain visible when said article is viewed.

2. The substantially rigid, fiber reinforced polymer composite article of claim 1, wherein said article is hollow.

3. The substantially rigid, fiber reinforced polymer composite article of claim 1, wherein said elongated fibers are coated with a thermoplastic polymer that binds said fibers together when heated to a predetermined temperature.

4. The substantially rigid, fiber reinforced polymer composite article of claim 1, wherein said predetermined pattern is printed onto said veil.

5. The substantially rigid, fiber reinforced polymer composite article of claim 4, wherein said polymer veil layer includes a wood grain pattern.

6. The substantially rigid, fiber reinforced polymer composite article of claim 1 wherein the polymer of said veil is polypropylene.

7. The substantially rigid, fiber reinforced polymer composite article of claim 1, wherein the polymer of said veil is nylon.

8. The substantially rigid, fiber reinforced polymer composite article of claim 1, wherein said fibers are fiberglass.

9. An elongated and substantially rigid, fiber reinforced polymer composite article having predetermined dimensions and an outwardly visible pattern when said article is viewed, said article comprising:
a substantially rigid core layer formed from a plurality of thermoplastic coated fibers, said fibers being binded together by said thermoplastic coating;
a polymer veil layer substantially disposed about and binded to said core layer, said polymer veil layer having a printed pattern that is outwardly visible when said article is viewed; and
a substantially transparent polymer layer that is binded to a substantial portion of said veil layer, wherein said capstock permits said printed pattern of said veil layer to remain visible when said article is viewed.

10. The elongated and substantially rigid, fiber reinforced polymer composite article of claim 9, wherein said polymer veil layer includes a wood grain pattern.

11. The elongated and substantially rigid, fiber reinforced polymer composite article of claim 9, wherein the polymer of said veil is polyester.

12. The elongated and substantially rigid, fiber reinforced polymer composite article of claim 9, wherein the polymer of said veil is nylon.

13. The elongated and substantially rigid, fiber reinforced polymer composite article of claim 9, wherein said fibers are fiberglass.

14. The elongated and substantially rigid, fiber reinforced polymer composite article of claim 9, wherein said thermoplastic coating on said fibers is polypropylene.

15. A method for the manufacture of fiber reinforced polymer composite articles comprising the steps of:
heating a plurality of thermoplastic encapsulated fibers;
pultruding said heated fibers through a plurality of dies, to form a profile comprising a plurality of longitudinal strands of fibers interconnected by said thermoplastic;
applying a polymer veil having a predetermined pattern substantially around said fiber and thermoplastic profile;
cooling said fiber and thermoplastic profile and veil; and
extruding a substantially transparent thermoplastic capstock over said polymer veil.

16. The method for the manufacture of fiber reinforced polymer composite articles of claim 15, wherein said fibers are fiberglass.

17. The method for the manufacture of fiber reinforced polymer composite articles of claim 15, wherein said thermoplastic is polypropylene.

18. The method for the manufacture of fiber reinforced polymer composite articles of claim 15, wherein said predetermined pattern is printed on said polymer veil.

19. The method for the manufacture of fiber reinforced polymer composite articles of claim 15, wherein said thermoplastic capstock is a polypropylene.

20. The method for the manufacture of fiber reinforced polymer composite articles of claim 15, wherein said article is cut to a predetermined length.

21. A method of forming a fiber reinforced polymer composite article comprising the steps of:
pulling thermoplastic encapsulated reinforcing fibers through a several forming dies to form a pultruded first layer with an outside surface;
applying a polymer veil having a predetermined pattern to said outside surface of said pultruded first layer;
cooling said pultruded first layer and said polymer veil by passing said combination through a chiller die; and
extruding a substantially transparent thermoplastic capstock over said polymer veil wherein said pattern on said polymer veil is visible through said capstock.

22. The method of forming a fiber reinforced polymer composite article of claim 21, wherein said fibers are fiberglass.

23. The method of forming a fiber reinforced polymer composite article of claim 21, wherein said thermoplastic is polypropylene.

24. The method of forming a fiber reinforced polymer composite article of claim 21, wherein said predetermined pattern is printed on said polymer veil.

25. The method of forming a fiber reinforced polymer composite article of claim 21, wherein said thermoplastic capstock is a polypropylene.

26. The method of forming a fiber reinforced polymer composite article of claim 21, wherein said article is cut to a predetermined length.
